(19) United States
(12) Patent Application Publication
(10) Pub. No.: US 2023/0026811 A1
(43) Pub. Date: Jan. 26, 2023

(54) SYSTEM AND METHOD FOR REMOVING HAZE FROM REMOTE SENSING IMAGES

(71) Applicant: PING AN TECHNOLOGY (SHENZHEN) CO., LTD., Shenzhen (CN)

(72) Inventors: HANG ZHOU, Santa Clara, CA (US); JUIHSIN LAI, Santa Clara, CA (US); MEI HAN, Palo Alto, CA (US)

(73) Assignee: PING AN TECHNOLOGY (SHENZHEN) CO., LTD., Shenzhen (CN)

(21) Appl. No.: 17/377,359

(22) Filed: Jul. 15, 2021

(51) Int. Cl. G06T 5/00; G06T 7/11; G06K 9/62; G06K 9/46; G06K 9/00

(52) U.S. Cl. CPC G06T 5/002; G06T 7/11; G06K 9/6256; G06K 9/4661; G06K 9/00657; G06T 2207/20081; G06T 2207/20021; G06T 2207/10036; G06T 2207/30188

(57) ABSTRACT

A system and a method for removing haze from remote sensing images are disclosed. One or more hazy input images with at least four spectral channels and one or more target images with the at least four spectral channels are generated. The one or more hazy input images correspond to the one or more target images, respectively. A dehazing deep learning model is trained using the one or more hazy input images and the one or more target images. The dehazing deep learning model is provided for haze removal processing.

### TECHNICAL FIELD

The present disclosure relates to image processing, and more particularly, to a system and method for removing haze from remote sensing images.

### BACKGROUND

Remote sensing images can be widely used in various application fields including agriculture, city planning, forests monitoring, mine investigation and surveillance, etc. Imaging quality of a remote sensing image may be susceptible to a weather condition at the time when the remote sensing image is captured. For example, haze may have an obvious impact on the imaging quality of the remote sensing image such that heavy haze may lead to a production of an unclear or blurred remote sensing image.

Specifically, haze may include tiny particles present in the air, such as water vapor, dust, smoke, fog, etc. Haze may affect an atmospheric transmittance and increase scattered light in an atmospheric background. Presence of haze in the air may be equivalent to adding a frosted glass to various spectral channels, incurring mist-like blurriness in a produced remote sensing image.

Besides, presence of haze in the air may reduce visibility of the atmosphere, and thus, clarity and contrast of the produced remote sensing image may be degraded. Therefore, a numerical value of an image analysis parameter based on the produced remote sensing image may be deviated significantly from its true value, which may limit further interpretation and applications of the produced remote sensing image. As a result, it is meaningful to reduce or remove the haze effect on the produced remote sensing image.

### SUMMARY

In one aspect, a method for removing haze from remote sensing images is disclosed. One or more hazy input images with at least four spectral channels and one or more target images with the at least four spectral channels are generated. The one or more hazy input images correspond to the one or more target images, respectively. A dehazing deep learning model is trained using the one or more hazy input images and the one or more target images. The dehazing deep learning model is provided for haze removal processing.

In another aspect, a system for removing haze from remote sensing images is disclosed. The system includes a memory configured to store instructions and a processor coupled to the memory and configured to execute the instructions to perform a process. The process includes generating one or more hazy input images with at least four spectral channels and one or more target images with the at least four spectral channels. The one or more hazy input images correspond to the one or more target images, respectively. The process further includes training a dehazing deep learning model using the one or more hazy input images and the one or more target images. The process additionally includes providing the dehazing deep learning model for haze removal processing.

In yet another aspect, a non-transitory computer-readable storage medium is disclosed. The non-transitory computer-readable storage medium is configured to store instructions which, in response to an execution by a processor, cause the processor to perform a process. The process includes generating one or more hazy input images with at least four spectral channels and one or more target images with the at least four spectral channels. The one or more hazy input images correspond to the one or more target images, respectively. The process further includes training a dehazing deep learning model using the one or more hazy input images and the one or more target images. The process additionally includes providing the dehazing deep learning model for haze removal processing.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated herein and form a part of the specification, illustrate implementations of the present disclosure and, together with the description, further serve to explain the present disclosure and to enable a person skilled in the pertinent art to make and use the present disclosure.

FIG. 1 illustrates a block diagram of an exemplary operating environment for a system configured to remove haze from remote sensing images, according to embodiments of the disclosure.

FIG. 2 illustrates a schematic diagram of an exemplary process for removing haze from remote sensing images, according to embodiments of the disclosure.

FIG. 3A illustrates a schematic diagram of an exemplary structure of a dehazing deep learning model, according to embodiments of the disclosure.

FIG. 3B illustrates a schematic diagram of an exemplary structure of a group block in the dehazing deep learning model of FIG. 3A, according to embodiments of the disclosure.

FIG. 3C illustrates a schematic diagram of an exemplary structure of a basic block in the group block of FIG. 3B, according to embodiments of the disclosure.

FIG. 3D illustrates a schematic diagram of an exemplary structure of a feature attention module in the dehazing deep learning model of FIG. 3A, according to embodiments of the disclosure.

FIG. 4 is a flowchart of an exemplary method for removing haze from remote sensing images, according to embodiments of the disclosure.

FIG. 5 is a flowchart of an exemplary method for training a dehazing deep learning model, according to embodiments of the disclosure.

FIG. 6 illustrates an exemplary process for providing a dehazed remote sensing image in response to a user inquiry, according to embodiments of the disclosure.

FIG. 7 is a flowchart of an exemplary method for providing a dehazed remote sensing image, according to embodiments of the disclosure.

FIG. 8 is a graphical representation illustrating an exemplary comparison of a hazy input image, a target image, and an output image, according to embodiments of the disclosure.

FIG. 9 is a graphical representation illustrating an exemplary normalized differential vegetation index (NDVI), according to embodiments of the disclosure.

FIG. 10 is a graphical representation illustrating an exemplary performance of a dehazing deep learning model, according to embodiments of the disclosure.

Implementations of the present disclosure will be described with reference to the accompanying drawings.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

In some applications, an absolute atmospheric correction method can be used to remove atmospheric effects from remote sensing images. For example, based on an atmospheric radiation transmission physical process, digital number (DN) values of remote sensing images can be converted into surface radiation brightness and surface reflectance. Various techniques have been developed to reduce or eliminate the influence of solar irradiance as well as atmospheric and sensor differences on the remote sensing images. These techniques are complicated and use a series of complicated atmospheric physical parameters, many of which are difficult to be measured accurately.

For example, haze may generally have an uneven distribution and thickness. It can be a challenge to process different degrees of haze present in the atmosphere using the atmospheric physical parameters to obtain a consistent dehazing effect. In actual practice, the absolute atmospheric correction method usually requires a combination of different atmospheric remote sensing data and meteorological model data to provide reasonable atmospheric physical parameters for removing atmospheric effects (e.g., a haze effect) from the remote sensing images. Operation, maintenance, and management of the absolute atmospheric correction method can be expensive.

In some applications, other methods such as homomorphic filtering or wavelet transform can be applied. However, these methods may have problems such as a limited processing effect, difficulty in parameter setting, and difficulty in adjusting a computing speed to satisfy the processing of remote sensing images with a large data volume.

In some applications, deep learning models used for haze removal are only applicable to images with three channels (e.g., red, green, blue (RGB) channels). However, analysis of the remote sensing images usually needs information of one or more additional spectral channels in addition to information of the RGB channels. For example, information of four channels (e.g., red, green, blue, and near infrared) or even more channels (including, e.g., shortwave infrared, mid-wave infrared, etc.) in the remote sensing images may be needed for agricultural applications. Existing technologies for removing haze from the multi-spectral remote sensing images are not mature. Additionally, it can be difficult to obtain a training dataset with a large number of hazy images and corresponding haze-free images for training a deep learning model, especially in the field of remote sensing, since availability of remote sensing images is limited.

In this disclosure, a system and method for removing haze from remote sensing images are disclosed. A training dataset can be generated to include one or more hazy input images with at least four spectral channels and one or more target images with the at least four spectral channels. The training dataset can be used to train a dehazing deep learning model such that the trained dehazing deep learning model can be applied to reduce or remove a haze effect from remote sensing images.

For example, in order to generate the training dataset, a large number of image pairs each captured within a predetermined time window can be selected from a Sentinel-2 data source due to a high revisit frequency of Sentinel-2 satellites. Each image pair may include two original remote sensing images taken for an identical geographical location with a captured time difference not greater than 5 days apart. An average dark-channel value can be used to evaluate a degree of haze in a particular remote sensing image. Only image pairs that satisfy a dark-channel value condition can be used to generate hazy input images and target images in the training dataset. The training dataset may include numerous hazy input images and numerous corresponding target images for training the dehazing deep learning model disclosed herein. For example, the training dataset may include hazy input images with different degrees of haze (e.g., light haze, medium haze, or heavy haze) and different haze distribution in different geographical areas.

Consistent with the disclosure, the dehazing deep learning model disclosed herein can process hazy input images with at least four spectral channels simultaneously, which is different from a deep learning model that processes hazy images only with the RGB channels. During a training process of the dehazing deep learning model, a loss function based at least in part on a crop growth analysis parameter can be introduced into the dehazing deep learning model for adjusting one or more parameters (or weights) of the model. After the dehazing deep learning model is trained, a value of the crop growth analysis parameter can be determined using dehazed remote sensing images outputted by the trained dehazing deep learning model. Thus, a growth status of crops on a farmland may be monitored through an application of the dehazing deep learning model even in a hazy geographical region.

Consistent with the disclosure, by using the training dataset with different degrees of haze and different haze distributions in different geographical areas, the dehazing deep learning model disclosed herein can be used to process remote sensing images with different degrees of haze and different haze distributions. The dehazing deep learning model can be used in various application scenarios to improve imaging quality of remote sensing images. For example, the dehazing deep learning model can be used in an agricultural application for monitoring and analyzing a growth trend of crops on a farmland even if the farmland is located in a geographical region with heavy haze. Thus, through an application of the dehazing deep learning model, monitoring of the crops can be performed in a wide spatial area including geographical regions with heavy haze.

Consistent with the disclosure, an atmospheric physical model can be introduced into the dehazing deep learning model disclosed herein during the training process. For example, virtual hazy images can be generated from haze-free target images using the atmospheric physical model. Absolute atmospheric correction can be performed on the virtual hazy images based on different atmospheric physical parameters so that a plurality of positive samples and a plurality of negative samples can be generated for training the dehazing deep learning model. As a result, information of the atmospheric physical model can be incorporated into the dehazing deep learning model during the training process to improve a dehazing performance of the model.

In some embodiments, a geographical location of an image (e.g., a remote sensing image) described herein can be, for example, a geographic location of a reference point (e.g., a center point) in the image, or a geographical location of a scene (or a place of interest) captured by the image. Consistent with the disclosure, if a first image corresponds to a second image, the first and second images may capture a scene of the same geographical location within a predetermined time window (e.g., within 5 days). For example, a geographical location of a reference point of the first image is identical to a geographical location of a reference point of the second image, and the first and second images are captured within a predetermined time window.

In some embodiments, a hazy image disclosed herein can be an image with a degree of haze being greater than a predetermined hazy threshold. For example, a hazy image can be an image with an average dark-channel value being equal to or greater than a first dark-channel threshold. A haze-free image disclosed herein can be an image with a degree of haze being less than a predetermined haze-free threshold. For example, a haze-free image can be an image with an average dark-channel value being less than a second dark-channel threshold. The first dark-channel threshold can be equal to or greater than the second dark-channel threshold. The average dark-channel value is described below in more details.

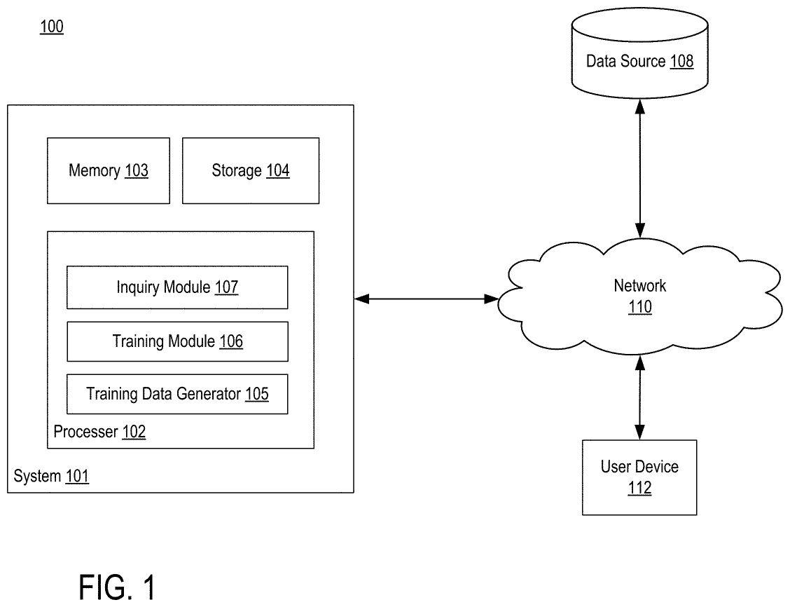

FIG. 1 illustrates an exemplary operating environment 100 for a system 101 configured to remove haze from remote sensing images, according to embodiments of the disclosure. Operating environment 100 may include system 101, a data source 108, a user device 112, and any other suitable components. Components of operating environment 100 may be coupled to each other through a network 110.

In some embodiments, system 101 may be embodied on a computing device. The computing device can be, for example, a server, a desktop computer, a laptop computer, a tablet computer, a working station, or any other suitable electronic device including a processor and a memory. In some embodiments, system 101 may include a processor 102, a memory 103, and a storage 104. It is understood that system 101 may also include any other suitable components for performing functions described herein.

In some embodiments, system 101 may have different components in a single device, such as an integrated circuit (IC) chip, or separate devices with dedicated functions. For example, the IC may be implemented as an application-specific integrated circuit (ASIC) or a field-programmable gate array (FPGA). In some embodiments, one or more components of system 101 may be located in a cloud computing environment or may be alternatively in a single location or distributed locations. In some embodiments, components of system 101 may be in an integrated device or distributed at different locations but communicate with each other through network 110.

Processor 102 may include any appropriate type of microprocessor, digital signal processor, microcontroller, graphics processing unit (GPU), etc. Processor 102 may include one or more hardware units (e.g., portion(s) of an integrated circuit) designed for use with other components or to execute part of a program. The program may be stored on a computer-readable medium, and when executed by processor 102, it may perform one or more functions. Processor 102 may be configured as a separate processor module dedicated to image processing. Alternatively, processor 102 may be configured as a shared processor module for performing other functions unrelated to image processing.

Processor 102 may include several modules, such as a training data generator 105, a training module 106, and an inquiry module 107. Although FIG. 1 shows that training data generator 105, training module 106, and inquiry module 107 are within one processor 102, they may also be likely implemented on different processors located closely or remotely with each other. For example, training data generator 105 and training module 106 may be implemented by a processor (e.g., a GPU) dedicated to off-line training, and inquiry module 107 may be implemented by another processor for generating dehazed remote sensing images responsive to user inquiries.

Training data generator 105, training module 106, and inquiry module 107 (and any corresponding sub-modules or sub-units) can be hardware units (e.g., portions of an integrated circuit) of processor 102 designed for use with other components or software units implemented by processor 102 through executing at least part of a program. The program may be stored on a computer-readable medium, such as memory 103 or storage 104, and when executed by processor 102, it may perform one or more functions.

Memory 103 and storage 104 may include any appropriate type of mass storage provided to store any type of information that processor 102 may need to operate. For example, memory 103 and storage 104 may be a volatile or non-volatile, magnetic, semiconductor-based, tape-based, optical, removable, non-removable, or other type of storage device or tangible (i.e., non-transitory) computer-readable medium including, but not limited to, a ROM, a flash memory, a dynamic RAM, and a static RAM. Memory 103 and/or storage 104 may be configured to store one or more computer programs that may be executed by processor 102 to perform functions disclosed herein. For example, memory 103 and/or storage 104 may be configured to store program(s) that may be executed by processor 102 to remove haze from remote sensing images. Memory 103 and/or storage 104 may be further configured to store information and data used by processor 102.

Data source 108 may include one or more storage devices configured to store remote sensing images. The remote sensing images can be captured by cameras installed in satellites, manned or unmanned aircrafts such as unmanned aerial vehicles (UAVs), hot balloons, etc. For example, data source 108 may be a Sentinel-2 data source or any other suitable type of remote sensing data source. Although FIG. 1 illustrates that system 101 and data source 108 are separate from each other, in some embodiments data source 108 and system 101 can be integrated into a single device.

User device 112 can be a computing device including a processor and a memory. For example, user device 112 can be a desktop computer, a laptop computer, a tablet computer, a smartphone, a game controller, a television (TV) set, a music player, a wearable electronic device such as a smart watch, an Internet-of-Things (IoT) appliance, a smart vehicle, or any other suitable electronic device with a processor and a memory. Although FIG. 1 illustrates that system 101 and user device 112 are separate from each other, in some embodiments user device 112 and system 101 can be integrated into a single device.

In some embodiments, a user may operate on user device 112 and may input a user inquiry through user device 112. User device 112 may send the user inquiry to system 101 through network 110. The user inquiry may include one or more parameters for requesting a dehazed remote sensing image. The one or more parameters may include one or more of a location (or a geographical region of interest), a specified time (or a specified time window), a size of the requested dehazed remote sensing image, etc. The location can be a geographical location or a surface location on Earth. For example, the location can include a longitude and a latitude, an address (e.g., a street, city, state, country, etc.), a place of interest, etc. The dehazed remote sensing image may depict a scene or a landscape at the location.

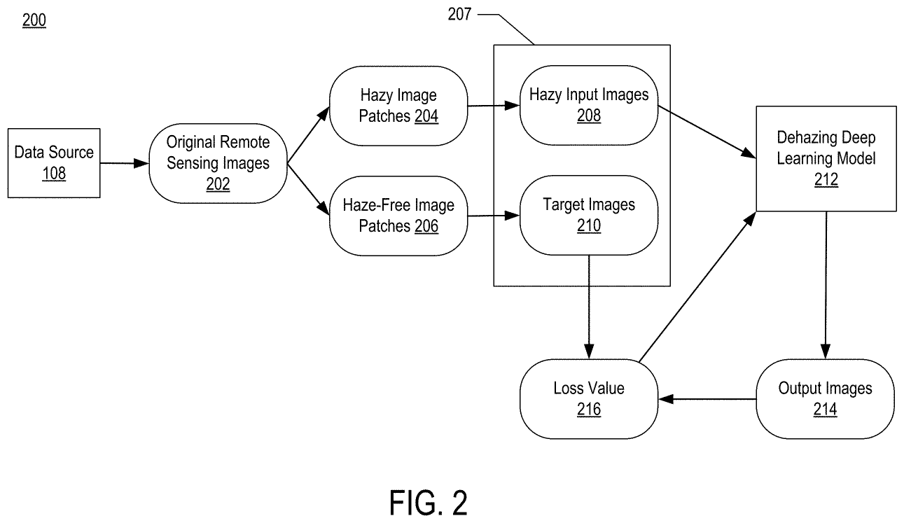

FIG. 2 illustrates a schematic diagram of an exemplary process 200 for removing haze from remote sensing images, according to embodiments of the disclosure. In some embodiments, training data generator 105 may be configured to generate a training dataset 207 from data source 108. Training dataset 207 may include one or more hazy input images 208 with at least four spectral channels and one or more target images 210 with the at least four spectral channels. One or more hazy input images 208 may correspond to one or more target images 210, respectively. The at least four spectral channels may include a red channel, a green channel, a blue channel, and a near infrared channel. In some embodiments, the at least four spectral channels may further include one or more of a shortwave infrared channel, a mid-wave infrared channel, etc.

Specifically, training data generator 105 may retrieve multiple pairs of original remote sensing images 202 from data source 108. Each retrieved pair of original remote sensing images 202 may include a first original image and a second original image. The first original image may correspond to the second original image. For example, the first and second original images may be original remote sensing images 202 captured within a predetermined time window for an identical geographical location.

For each retrieved pair of original remote sensing images 202, training data generator 105 may determine an average dark-channel value for the first original image and an average dark-channel value for the second original image. For example, based on the following expression (1), training data generator 105 may determine average dark-channel values for the first and second original images, respectively.

Consistent with the disclosure, an average dark-channel value for an image may be used to evaluate a degree of haze in the image. In some embodiments, each pixel may include three pixel values corresponding to the RGB channels, respectively. A minimal RGB value of the pixel can be a minimum of the three pixel values corresponding to the RGB channels of the pixel (e.g., equivalent to a pixel value of a “dark” channel of the pixel). An average dark-channel value can be calculated as an average of minimal RGB values for pixels in the image. For example, an average dark-channel value Value_{DC} for an image with M×N pixels can be calculated using the following expression (1):

$${Value}_{D C} = \frac{1}{M \times N} {\sum }_{i = 1}^{M} {\sum }_{j = 1}^{N} min ( {VR}_{i , j} , V {G}_{i , j} , V {B}_{i , j} ) \qquad ( 1 )$$

In the above expression (1), VRᵢⱼ, VGᵢⱼ, and VBᵢⱼ denote pixel values for the RGB channels of a pixel (i,j) in the image, respectively, and min (VRᵢⱼ, VGᵢⱼ, VBᵢⱼ) denotes a minimum RGB value of the pixel (i,j), which is a minimum of VRᵢⱼ, VGᵢⱼ, and VBᵢⱼ.

Consistent with the disclosure, a color of a hazy image is whitened when compared to a corresponding haze-free image. For the corresponding haze-free image, at least one of the pixel values corresponding to the RGB channels may be relatively small. However, the pixel values corresponding to the RGB channels in the hazy image are relatively large when compared to those in the corresponding haze-free image. That is, the corresponding haze-free image appears to be “darker” than the hazy image, with a smaller average dark-channel value than that of the hazy image. Since an average dark-channel value can be calculated as an average of minimal RGB values of pixels in an image, the average dark-channel value can be used to measure a degree of haze in the image. A larger average dark-channel value may indicate a higher degree of haze in the image.

Next, for each retrieved pair of original remote sensing images 202, if the average dark-channel value of the first original image is equal to or greater than a first dark-channel threshold and the average dark-channel value of the second original image is smaller than a second dark-channel threshold, training data generator 105 may determine the retrieved pair of original remote sensing images 202 to be a matched image pair. Otherwise, training data generator 105 may discard the retrieved pair of original remote sensing images 202. The first dark-channel threshold may be equal to or greater than the second dark-channel threshold. For example, both the first and second dark-channel thresholds can be equal to 20 or another suitable value. In another example, the first dark-channel threshold may be equal to or greater than 20, while the second dark-channel threshold can be less than 20.

As a result, by performing similar operations to the multiple retrieved pairs of original remote sensing images 202, training data generator 105 may determine a plurality of matched image pairs of original remote sensing images 202 for the generation of hazy image patches 204 and corresponding haze-free image patches 206.

Subsequently, for each matched image pair that includes a first original image and a second original image, training data generator 105 may generate at least one hazy image patch 204 from the first original image and at least one haze-free image patch 206 from the second original image. The at least one hazy image patch 204 may correspond to the at least one haze-free image patch 206, respectively.

For example, training data generator 105 may divide the first original image into a plurality of first image patches and the second original image into a plurality of second image patches. The plurality of first image patches may correspond to the plurality of second image patches, respectively. For each first image patch, training data generator 105 may determine an average dark-channel value for the first image patch and an average dark-channel value for a second image patch corresponding to the first image patch. If the average dark-channel value of the first image patch is equal to or greater than the first dark-channel threshold and the average dark-channel value of the second image patch is smaller than the second dark-channel threshold, training data generator 105 may determine the first image patch to be a hazy image patch 204 and the second image patch to be a haze-free image patch 206 corresponding to the hazy image patch 204.

By performing similar operations to the plurality of first image patches of the first original image and the plurality of second image patches of the second original image in the matched image pair, training data generator 105 may generate at least one hazy image patch 204 and at least one haze-free image patch 206 from the first and second original images, respectively.

Also, by performing similar operations to the plurality of matched image pairs, training data generator 105 may generate a plurality of hazy image patches 204 and a plurality of corresponding haze-free image patches 206 from the matched image pairs of original remote sensing images 202. The plurality of hazy image patch 204 may correspond to the plurality of haze-free image patch 206, respectively.

Next, training data generator 105 may filter the plurality of hazy image patches 204 to generate a plurality of hazy input images 208 with at least four spectral channels. Training data generator 105 may also filter the plurality of haze-free image patches 206 to generate a plurality of target images 210 with the at least four spectral channels. For example, the plurality of hazy image patches 204 and the plurality of haze-free image patches 206 may be filtered to remove information of other spectral channels so that only information of the RGB channels and the near infrared channel are kept.

As a result, training data generator 105 may generate training dataset 207 including the plurality of hazy input images 208 and the plurality of target images 210. It is noted that only the pixel values of the RGB channels of each pixel are used to calculate an average dark-channel value of an original remote sensing image (or an image patch). However, hazy input images 208 and target images 210 in training dataset 207 may still have at least four spectral channels for training a dehazing deep learning model 212, so that a dehazed output image generated by dehazing deep learning model 212 may have the at least four spectral channels.

An exemplary process to generate a training data set from a Sentinel-2 data source is provided herein. Specifically, the Sentinel-2 data source may store a plurality of Sentinel-2 L2A remote sensing images (referred to as original Sentinel-2 images), and may also store a captured time and a geographical location of each of the original Sentinel-2 images. A challenge associated with the training data generation may include generating a large number of training image pairs with each training image pair including a hazy image and a haze-free image that are captured at the same time for the same geographical location. Since a change speed of surface features of satellite remote sensing images is relatively slow while a revisit frequency of Sentinel-2 satellites is relatively high (e.g., with a revisit time interval not exceeding 5 days), a large number of Sentinel-2 image pairs may be retrieved from the Sentinel-2 data source for the training data generation. Each retrieved Sentinel-2 image pair may include two original Sentinel-2 images that are captured within 5 days for an identical geographical location. It can be assumed that corresponding true surface features and corresponding true pixel values of the two original Sentinel-2 images are identical so that they can be used for the training data generation.

Training data generator 105 may determine a plurality of matched Sentinel-2 image pairs from the large number of retrieved Sentinel-2 image pairs. Each matched Sentinel-2 image pair may include (1) a first original Sentinel-2 image having an average dark-channel value equal to or greater than the first dark-channel threshold, and (2) a second original Sentinel-2 image having an average dark-channel value smaller than the second dark-channel threshold. The first original Sentinel-2 image may correspond to the second original Sentinel-2 image.

Each of the first and second original Sentinel-2 images may have a wide coverage area (e.g., an area of 10,000 square meters) with a size of 10,980*10,980 pixels, and haze may be distributed unevenly across the wide coverage area. The first and second original Sentinel-2 images may be divided into a plurality of first image patches and a plurality of second image patches, respectively. In some embodiments, training data generator 105 may utilize a Sentinel-2 scene classification layer (SCL) to ensure that a total image area in each first or second image patch that is occluded by clouds or has missing data is less than 1% of an entire image area of the first or second image patch. As a result, influence of clouds or influence of missing data on a training performance of dehazing deep learning model 212 can be reduced or eliminated.

Each first image patch and each second image patch may have a size of 1,024*1,024 pixels. Training data generator 105 may calculate an average dark-channel value for each first or second image patch. Training data generator 105 may determine one or more matched patch pairs from the plurality of first image patches and the plurality of second image patches. Each matched patch pair may include (1) a first image patch having an average dark-channel value equal to or greater than the first dark-channel threshold, and (2) a second image patch corresponding to the first image patch and having an average dark-channel value less than the second dark-channel threshold. The first image patch in the matched patch pair may be filtered to have the at least four spectral channels and used as a hazy input image. The second image patch in the matched patch pair may be filtered to have the at least four spectral channels and used as a corresponding target image.

In some embodiments, by performing similar operations to the plurality of matched Sentinel-2 image pairs, training data generator 105 may generate 50,000 matched patch pairs. Training data generator 105 may filter the 50,000 matched patch pairs to generate training dataset 207 with 50,000 hazy input images and 50,000 corresponding target images. Thus, sufficient training data can be provided to train dehazing deep learning model 212. Training dataset 207 generated herein may include diversified hazy input images and target images that cover various landscapes and various surface features in different weather conditions with different degrees of haze. Thus, a performance of dehazed deep learning model 212 can be improved after being trained using the diversified hazy input images and target images.

In some embodiments, training data generator 105 may perform data enhancement on training dataset 207 by incorporating an atmospheric physical model into dehazing deep learning model 212. An exemplary atmospheric physical model may be an atmospheric radiation transmission model such as the Second Simulation of the Satellite Signal in the

Solar Spectrum (6S) model. The 6S model can be used as a standard for absolute atmospheric correction on remote sensing data.

A forward mode of the atmospheric physical model can be used to calculate radiation received by satellite sensors for a given surface reflectance and a given atmospheric condition (e.g., a given water vapor ratio, a given atmospheric aerosol component ratio, etc.). A reverse mode of the atmospheric physical model can be used to calculate a corresponding surface reflectance based on a given radiation received by satellite sensors and a given atmospheric condition.

In some embodiments, target images 210 may be used as positive samples for training dehazing deep learning model 212. Training data generator 105 may generate corresponding negative samples for training dehazing deep learning model 212 based on target images 210 and the atmospheric physical model. The negative samples can include miss-corrected images generated from target images 210 through an application of the atmospheric physical model.

For example, training data generator 105 may generate one or more atmospheric physical parameters randomly. For each target image 210, training data generator 105 may apply a forward mode of the atmospheric physical model to target image 210 using the one or more randomly-generated atmospheric physical parameters, and may generate a virtual hazy image thereof. Then, training data generator 105 may modify the one or more atmospheric physical parameters randomly. Training data generator 105 may apply a reverse mode of the atmospheric physical model to the virtual hazy image using the one or more modified atmospheric physical parameters, and may generate a miss-corrected image thereof.

A miss-corrected image may include an over-corrected image or an under-corrected image. For example, by increasing a water vapor ratio or an atmospheric aerosol component ratio in the one or more atmospheric physical parameters, training data generator 105 may apply the reverse mode of the atmospheric physical model to generate an over-corrected image from the virtual hazy image. In another example, by decreasing the water vapor ratio or the atmospheric aerosol component ratio in the one or more atmospheric physical parameters, training data generator 105 may apply the reverse mode of the atmospheric physical model to generate an under-corrected image from the virtual hazy image.

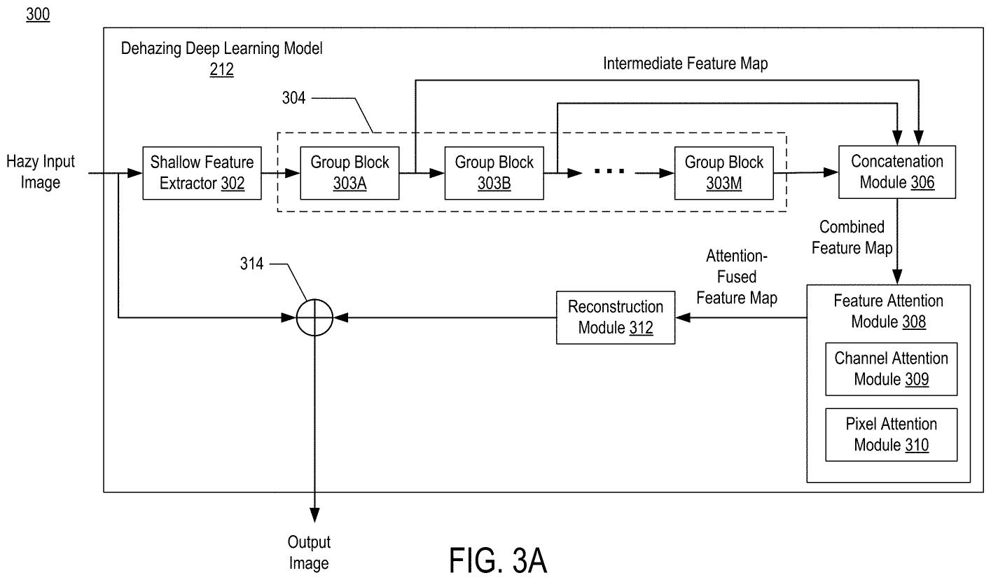

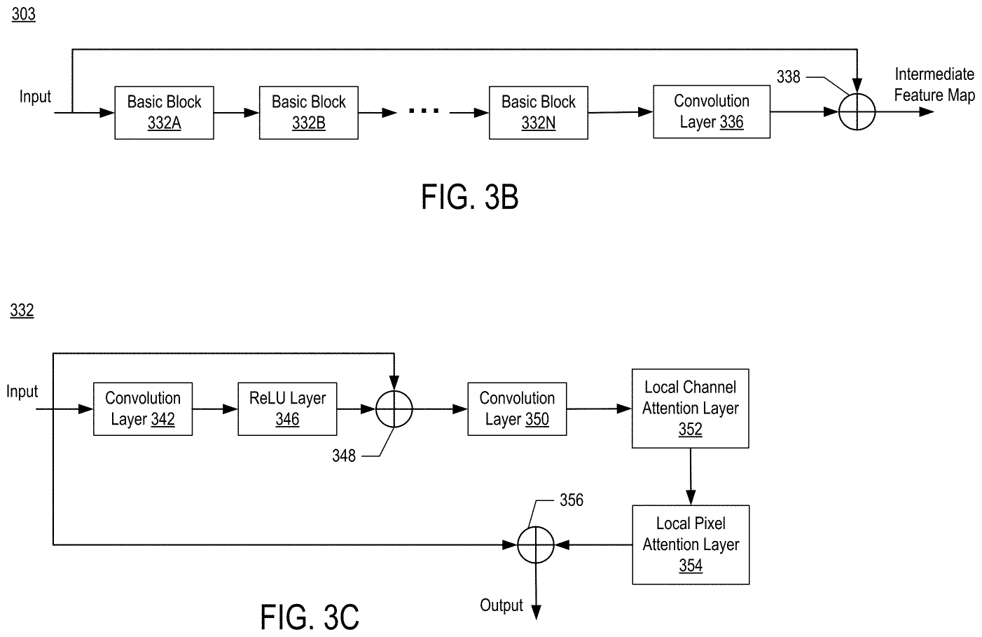

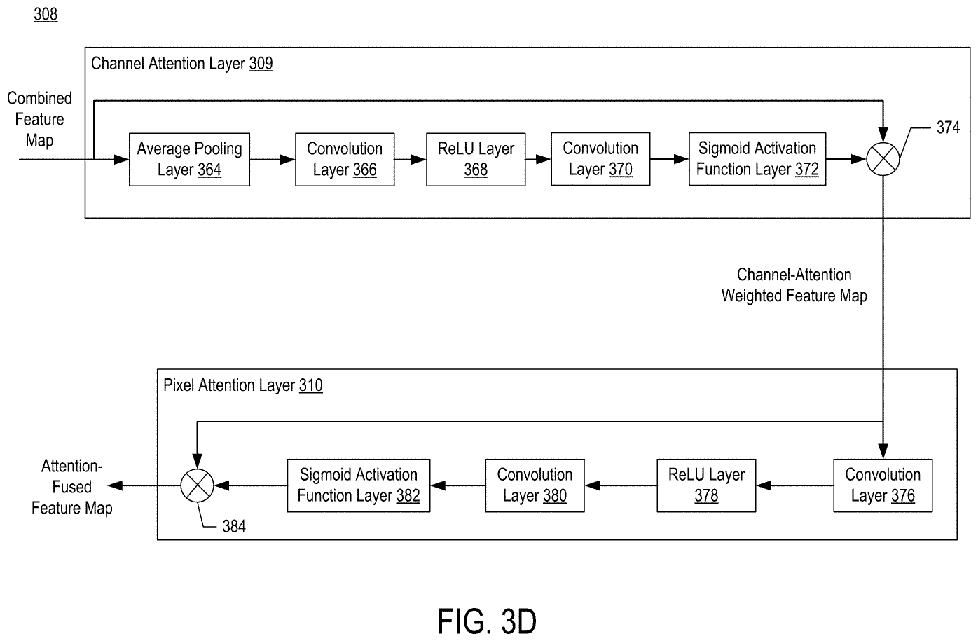

Training module 106 may be configured to receive training dataset 207 from training data generator 105. Training module 106 may train dehazing deep learning model 212 using training dataset 207, as described below in more details. A structure of dehazing deep learning model 212 is described below in more details with reference to FIGS. 3A-3D.

Specifically, training module 106 may feed one or more hazy input images 208 to dehazing deep learning model 212 to generate one or more output images 214. Training module 106 may determine a loss value 216 of dehazing deep learning model 212 based on one or more output images 214 and one or more target images 210 that correspond to one or more hazy input images 208, respectively. Training module 106 may adjust one or more parameters of dehazing deep learning model 212 based on loss value 216.

In some embodiments, an evaluation of a crop growth analysis parameter can be incorporated into dehazing deep learning model 212 through loss value 216 of dehazing deep learning model 212. The crop growth analysis parameter may include an NDVI parameter or any other suitable analysis parameter for analyzing a growth status of crops on a farmland. For example, a value of the NDVI parameter (also referred to as an NDVI value herein) for a pixel can be determined using the following expression (2):

$$VNdvi = \frac{VNIR - VR}{VNIR + VR} . \qquad ( 2 )$$

In the above expression (2), VNdvi denotes the value of the NDVI parameter for the pixel. VNIR and VR denote a pixel value of the near infrared (NIR) channel and a pixel value of the red channel for the pixel, respectively.

In some embodiments, training module 106 may determine, using pixels in one or more output images 214 and pixels in one or more target images 210, a first value of a first loss function with respect to the at least four spectral channels and/or the crop growth analysis parameter. In this case, loss value 216 of dehazing deep learning model 212 can be equal to the first value of the first loss function. The first loss function can include, for example, an L1 loss function, an L2 loss function, or any other suitable loss function. The first value of the first loss function can be propagated back to dehazing deep learning model 212 to optimize one or more parameters or weights of dehazing deep learning model 212.

For example, the first loss function can be an L1 loss function, and the first value of the first loss function can be determined using the following expression (3) with respect to the at least four spectral channels:

Value(1)=Σₖ₌₁^{K} Σᵢ₌₁^{M} Σⱼ₌₁^{N}(|VRTar_{i,j}^{k}−VROUt_{i,j}^{k}|+|VGTar_{i,j}^{k}−VGOut_{i,j}^{k}|+|VBTar_{i,j}^{k}−VBOut_{i,j}^{k}|+|VNIRTar_{i,j}^{k}−VNIROut_{i,j}^{k}|). (3)

In the above expression (3), Value(1) denotes the first value of the first loss function. K denotes a number of target images 210 (or a number of output images 214). Each target image 210 or each output image 214 may have a size of M×N pixels. VRTar_{i,j}^{k}, VGTar_{i,j}^{k}, VBTar_{i,j}^{k}, and VNIRTar_{i,j}^{k} denote pixel values for the RGB channels and the near infrared channel of a pixel (i, j) in a k^{th} target image, respectively, with 1≤k≤K. VROut_{i,j}^{k}, VGOut_{i,j}^{k}, VBOut_{i,j}^{k}, and VNIROut_{i,j}^{k} denote pixel values for the RGB channels and the near infrared channel of the pixel (i,j) in a k^{th} output image, respectively.

Alternatively, the first loss function can be an L1 loss function, and the first value of the first loss function can be determined using the following expression (4) with respect to the at least four spectral channels and the crop growth analysis parameter:

Value(1)=Σₖ₌₁^{K} Σᵢ₌₁^{M} Σⱼ₌₁^{N}(|VRTar_{i,j}^{k}−VROut_{i,j}^{k}|+|VGTar_{i,j}^{k}−VGOut_{i,j}^{k}|+|VBTar_{i,j}^{k}−VBOut_{i,j}^{k}|+|VNIRTar_{i,j}^{k}−VNIROut_{i,j}^{k}|+|VNdviTar_{i,j}^{k}−VNdviOut_{i,j}^{k}|). (4)

Compared to the expression (3), the expression (4) includes an additional term |VNdviTar_{i,j}^{k}−VNdviOut_{i,j}^{k}|. An evaluation of the crop growth analysis parameter (e.g., the NDVI parameter) can be incorporated into dehazing deep learning model 212 through the first value of the first loss function. VNdviTar_{i,j}^{k} and VNdviOut_{i,j}^{k} denote an NDVI value of the pixel (i,j) in the k^{th} target image and an NDVI value of the pixel (i,j) in the k^{th} output image, respectively.

In existing technologies, a learning process of a deep learning model may be purely driven by data without taking any physical mechanism into account, even though a large volume of prior knowledge has been accumulated for the atmospheric physical model. A forward mode of the atmospheric physical model is capable of converting a surface transmittance to a radiation received by satellite sensors. However, it can be difficult to provide reliable atmospheric physical parameters to apply a reverse mode of the atmospheric physical model to calculating a corresponding surface reflectance based on a given radiation received by satellite sensors. In terms of the above considerations, information of the atmospheric physical model can be incorporated into dehazing deep learning model 212 through loss value 216 of dehazing deep learning model 212.

In some embodiments, when calculating loss value 216 of dehazing deep learning model 212, a second loss function that incorporates the information of the atmospheric physical model into dehazing deep learning model 212 can be combined with the first loss function. The second loss function can include a contrastive loss function or any other suitable loss function. Training module 106 may determine a second value of the second loss function by applying the atmospheric physical model to one or more target images 210.

Specifically, training data generator 105 may apply a forward mode of the atmospheric physical model to one or more target images 210 to generate one or more virtual hazy images. Training data generator 105 may apply a reverse mode of the atmospheric physical model to the one or more virtual hazy images to generate one or more miss-corrected images. Then, training module 106 may determine a second value of the second loss function based on one or more output images 214, one or more target images 210, and the one or more miss-corrected images. For example, the second loss function can be a contrastive loss function, and training module 106 may determine the second value of the contrastive loss function by using one or more target images 210 as positive samples, one or more output images 214 as anchor samples, and the one or more miss-corrected images as negative samples.

For example, the second value of the contrastive loss function can be calculated using the following expression (5):

$$Value ( 2 ) = {\sum }_{i}^{T} {w}_{i} \frac{D ( {G}_{i} ( P ) , {G}_{i} ( A ) )}{D ( {G}_{i} ( N ) , {G}_{i} ( A ) )} . \qquad ( 5 )$$

In the above expression (5), Value (2) denotes the second value of the second contrastive loss function. Gᵢ(X) denotes a function for extracting an i-th hidden feature from a given image X, where X can be a positive sample (P), an anchor sample (A), or a negative sample (N) corresponding to a hazy input image. For example, Gᵢ(X) can be an output from different layers of a pre-trained multi-band visual geometry group (VGG) network using the given image X as an input. wᵢ denotes a weight coefficient for the i-th hidden feature. T denotes a total number of hidden features extracted from the given image.

The anchor sample (A) can be, for example, a corresponding output image from dehazing deep learning model 212 using the hazy input mage as an input. D(Y,Z) denotes a distance between Y and Z, where Y can be Gᵢ(P) or Gᵢ(N), and Z can be Gᵢ(A). For example, D(Y,Z) can be an L1 distance between Y and Z.

By using the contrastive loss function, output images 214 of dehazing deep learning model 212 can be optimized to keep away from the negative samples while attempting to approach the positive samples. As a result, the information of the atmospheric physical model can be incorporated into dehazing learning model 212.

Training module 106 may combine the first value of the first loss function and the second value of the second loss function to generate loss value 216. For example, loss value 216 can be a weighted sum of the first value of the first loss function and the second value of the second loss function. The second value of the second loss function can serve as a regularization term for the first value of the first loss function. For example, loss value 216 can be determined using the following expression (6):

Loss value=Value(1)+a×Value(2). (6)

In the above expression, Value(2) denotes the second value of the second loss function, and a denotes a weight of the second value of the second loss function.

In some embodiments, the training process of dehazing deep learning model 212 may stop if loss value 216 decreases and becomes smaller than a predetermined error. Then, a structure and parameters of the trained dehazing deep learning model 212 can be stored in memory 103 or storage 104 for later use.

FIG. 3A illustrates a schematic diagram of an exemplary structure 300 of dehazing deep learning model 212 for haze removal processing, according to embodiments of the disclosure. Dehazing deep learning model 212 may be configured to process a hazy input image with at least four spectral channels to generate an output image with the at least four spectral channels. For example, haze in the hazy input image can be removed or reduced through a processing of dehazing deep learning model 212 so that the output image can be a haze-free (or dehazed) image corresponding to the hazy input image.

In some embodiments, structure 300 of dehazing deep learning model 212 may be similar to an encoder-decoder structure. In some embodiments, dehazing deep learning model 212 may include a modified structure of a feature fusion attention network (FFA-net) adapted to process remote sensing images with at least four spectral channels. Dehazing deep learning model 212 may include a shallow feature extractor 302, a group structure 304, a concatenation module 306, a feature attention module 308, a reconstruction module 312, and an adder 314. Group structure 304 may include a series of group blocks 303A, 303B, . . . , 303M (also referred to as group block 303, individually or collectively) that are applied in series. Feature attention module 308 may include a channel attention module 309 and a pixel attention module 310.

Shallow feature extractor 302 may include a convolution layer. Reconstruction module 310 may include one or more convolution layers. Adder 314 can be an elementwise adder for calculating an elementwise sum. Group block 303 is described below in more details with reference to FIGS. 3B-3C. Feature attention module 308 is described below in more details with reference to FIG. 3D.

During an operation process of dehazing deep learning model 212, the hazy input image can be fed into dehazing deep learning model 212, and processed by shallow feature extractor 302 and group structure 304 to generate a plurality of intermediate feature maps. The plurality of intermediate feature maps can be concatenated by concatenation module 306 to generate a combined feature map. Then, the combined feature map can be processed by feature attention module 308 to generate an attention-fused feature map, which is then reconstructed by reconstruction module 312 to generate a reconstructed image. The hazy input image may be added to the reconstructed image elementwise using adder 314 to generate the output image.

In some embodiments, channel attention module 309 may be configured to determine weights for different channels in the combined feature map to generate a channel weighted map for the combined feature map. Channel attention module 309 may multiply the combined feature map with the channel weighted map elementwise to generate a channel-attention weighted feature map. Pixel attention module 309 may be configured to determine weights for different pixels in the channel-attention weighted feature map to generate a pixel weighted map. Pixel attention module 310 may multiply the channel-attention weighted feature map with the pixel weighted map elementwise to generate the attention-fused feature map. The attention-fused feature map can be a feature map fused with channel attention and pixel attention.

Through the processing of channel attention module 309 and pixel attention module 310, dehazing learning module 212 may be configured to pay more attention to a hazy image area within the hazy input image and less attention to a haze-free image area within the hazy input image. For example, different weights may be applied to image areas having different degrees of haze such that an image area with heavy haze may have a higher weight than an image area with light haze. As a result, dehazing learning module 212 can process hazy input images having different degrees of haze and different distributions of haze.

It is noted that structure 300 of dehazing deep learning model 212 may include a plurality of skip connections, which allows information of prior network layers in the model to skip one or more intermediate network layers and directly pass to subsequent network layers in the model. Thus, the information of the prior network layers can be directly combined or concatenated together to feed into the subsequent network layers. The propagation of the information from the prior network layers to the subsequent network layers can speed up a parameter adjustment of dehazing deep learning model 212 and improve a training performance of dehazing deep learning model 212.

FIG. 3B illustrates a schematic diagram of an exemplary structure of group block 303 in dehazing deep learning model 212 of FIG. 3A, according to embodiments of the disclosure. Group block 303 may include a plurality of basic blocks 332A, 332B, . . . , 332N (also referred to as basic block 332, individually or collectively), a convolution layer 336, and an adder 338. The plurality of basic blocks 332A, 332B, . . . , 332N and convolution layer 336 may be serially connected in group block 303. An input of group block 303 may be processed by the plurality of basic blocks 332A, 332B, . . . , 332N and convolution layer 336 to generate a group-block intermediate result. Then, the group-block intermediate result may be added to the input of group block 303 elementwise by adder 338 to generate an intermediate feature map.

FIG. 3C illustrates a schematic diagram of an exemplary structure of basic block 332 in group block 303 of FIG. 3B, according to embodiments of the disclosure. Basic block 332 may include a convolution layer 342, a rectified linear unit (ReLU) layer 346, an adder 348, a convolution layer 350, a local channel attention layer 352, a local pixel attention layer 354, and an adder 356. Local channel attention layer 352 may have a structure similar to that of channel attention layer 309 and perform functions similar to those of channel attention layer 309. Local pixel attention layer 354 may have a structure similar to that of pixel attention layer 310 and perform functions similar to those of pixel attention layer 310. The similar description will not be repeated here.

An input of basic block 332 may be processed by convolution layer 342 and ReLU layer 346 to generate a first basic-block intermediate result. The input of basic block 332 may be added to the first basic-block intermediate result elementwise by adder 348 to generate a second basic-block intermediate result. The second basic-block intermediate result may be processed by convolution layer 350, local channel attention layer 352, and local pixel attention layer 354 to generate a third basic-block intermediate result. The third basic-block intermediate result may be added to the input of basic block 332 elementwise by adder 356 to generate an output of basic block 332.

FIG. 3D illustrates a schematic diagram of an exemplary structure of feature attention module 308 in dehazing deep learning model 212 of FIG. 3A, according to embodiments of the disclosure. Feature attention module 308 may include channel attention module 309 and pixel attention layer 310. Feature attention module 308 may use a combined feature map from concatenation module 306 as an input and generate an attention-fused feature map as an output.

In some embodiments, channel attention module 309 may include an average pooling layer 364, a convolution layer 366, a ReLU layer 368, a convolution layer 370, a sigmoid activation function layer 372, and an elementwise multiplier 374 that are connected in series. The combined feature map may be processed by average pooling layer 364, convolution layer 366, ReLU layer 368, convolution layer 370, and sigmoid activation function layer 372 to generate a first attention intermediate result. The first attention intermediate result may be multiplied with the combined feature map elementwise using elementwise multiplier 374 to generate a channel-attention weighted feature map.

In some embodiments, pixel attention module 310 may include a convolution layer 376, a ReLU layer 378, a convolution layer 380, a sigmoid activation function layer 382, and an elementwise multiplier 384 that are connected in series. The channel-attention weighted feature map may be processed by convolution layer 376, ReLU layer 378, convolution layer 380, and sigmoid activation function layer 382 to generate a second attention intermediate result. The second intermediate result may be multiplied with the channel-attention weighted feature map elementwise using elementwise multiplier 384 to generate the attention-fused feature map.

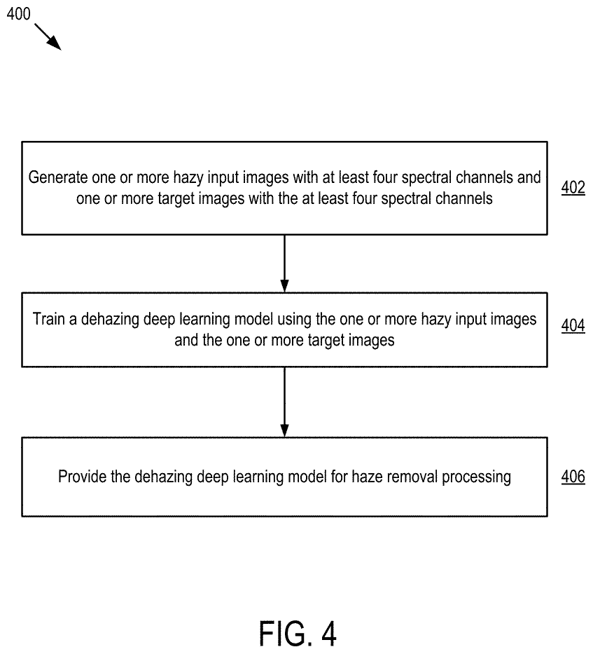

FIG. 4 is a flowchart of an exemplary method 400 for removing haze from remote sensing images, according to embodiments of the disclosure. Method 400 may be implemented by system 101, specifically training data generator 105 and training module 106, and may include steps 402-406 as described below. Some of the steps may be optional to perform the disclosure provided herein. Further, some of the steps may be performed simultaneously, or in a different order than that shown in FIG. 4.

At step 402, training data generator 105 generates one or more hazy input images with at least four spectral channels and one or more target images with the at least four spectral channels. The one or more hazy input images may correspond to the one or more target images, respectively.

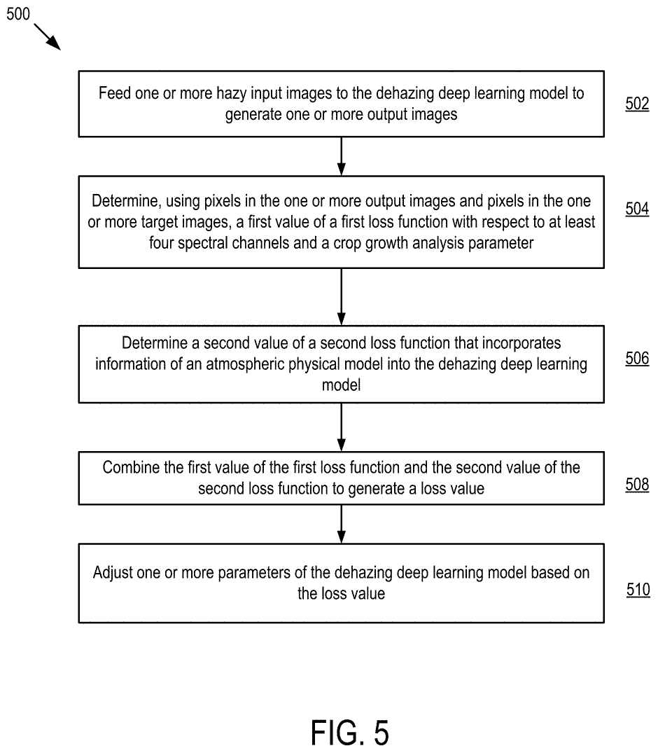

At step 404, training module 106 trains a dehazing deep learning model using the one or more hazy input images and the one or more target images. For example, training module 106 may perform operations similar to those described below with reference to FIG. 5 to train the dehazing deep learning model.

At step 406, training module 106 provides the dehazing deep learning model for haze removal processing. For example, training module 106 may store a structure and parameters of the trained dehazing deep learning model in storage 104, so that the trained dehazing deep learning model can be used for subsequent haze-removal processing.

FIG. 5 is a flowchart of an exemplary method 500 for training a dehazing deep learning model, according to embodiments of the disclosure. Method 500 may be implemented by system 101, specifically training module 106, and may include steps 502-510 as described below. Some of the steps may be optional to perform the disclosure provided herein. Further, some of the steps may be performed simultaneously, or in a different order than that shown in FIG. 5.

At step 502, training module 106 feeds one or more hazy input images to the dehazing deep learning model to generate one or more output images.

At step 504, training module 106 determines, using pixels in the one or more output images and pixels in the one or more target images, a first value of a first loss function with respect to at least four spectral channels and a crop growth analysis parameter.

At step 506, training module 106 determines a second value of a second loss function that incorporates information of an atmospheric physical model into the dehazing deep learning model.

At step 508, training module 106 combines the first value of the first loss function and the second value of the second loss function to generate a loss value of the dehazing deep learning model.

At step 510, training module 106 adjusts one or more parameters of the dehazing deep learning model based on the loss value.

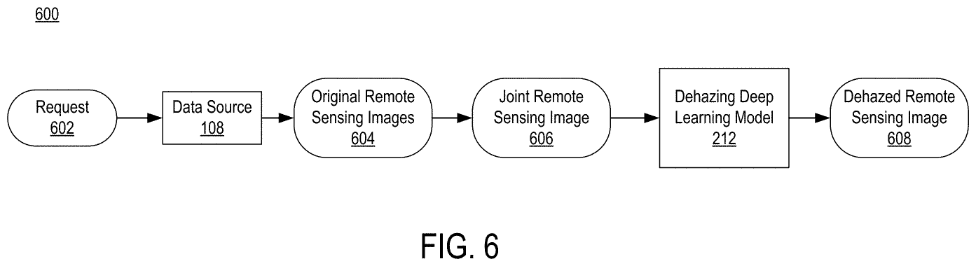

FIG. 6 illustrates an exemplary process 600 for providing a dehazed remote sensing image in response to a user inquiry, according to embodiments of the disclosure. A user may operate user device 112 to provide a request 602 to inquiry module 107. Request 602 may specify one or more parameters such as a coordinate of a geographical location, a time (e.g., a date of the year) or a time window, etc.

Inquiry module 107 may select a set of original remote sensing images 604 (e.g., image tiles) from data source 108 based on the one or more parameters. For example, each original remote sensing image 604 may capture a scene or landscape at the geographical location specified by the user. The set of original remote sensing images 604 are taken by cameras at different times within a time window close to the time specified by the user (or within the time window specified by the user).

In practice, some original remote sensing images 604 may be occluded by clouds, or data in some image areas of original remote sensing images 604 may be missing. Then, the set of original remote sensing images 604 may be processed using a Sentinel-2 SCL layer, respectively, and combined to generate a joint remote sensing image 606. For example, for each pixel in joint remote sensing image 606, a median of pixel values of the same pixel in the set of original remote sensing images 604 can be determined as a pixel value of the pixel in joint remote sensing image 606. As a result, joint remote sensing image 606 may have a de-clouding effect when compared to the set of original remote sensing images 604. Joint remote sensing image 606 may be filtered to keep information of the at least four spectral channels (e.g., the RGB channels and the near infrared channel).

Next, inquiry module 107 may apply joint remote sensing image 606 to dehazing deep learning model 212 to generate a dehazed remote sensing image 608. In some embodiments, an input image to dehazing deep learning model 212 may have a size of 1,024*1,024 pixels, and joint remote sensing image 606 may have a size greater than 1,024*1,024 pixels. Thus, inquiry module 107 may divide joint remote sensing image 606 into a set of input image patches each having the size of 1,024*1,024 pixels. Inquiry module 107 may feed each of the input image patches to dehazing deep learning model 212 to generate a corresponding dehazed output patch. As a result, a set of dehazed output patches may be generated using the set of input image patches, respectively. The set of dehazed output patches may be merged or stitched together to generate dehazed remote sensing image 608. Inquiry module 107 may then provide dehazed remote sensing image 608 to user device 112.

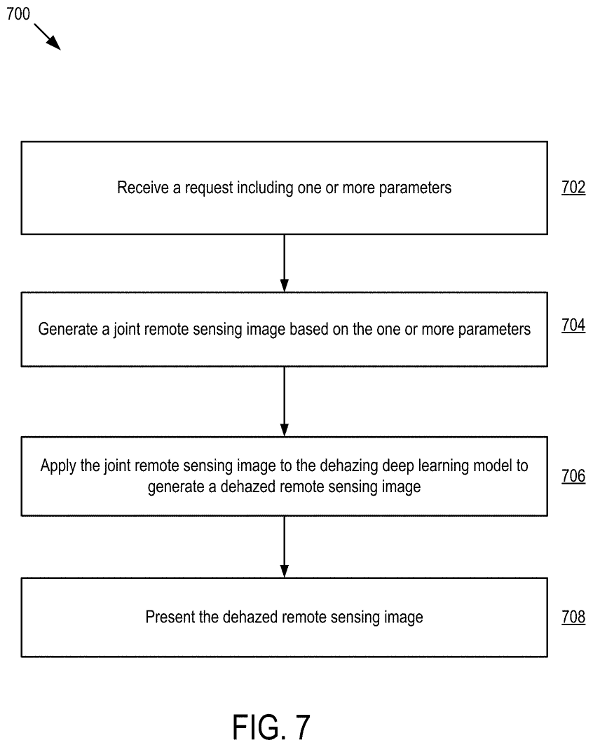

FIG. 7 is a flowchart of an exemplary method 700 for providing a dehazed remote sensing image, according to embodiments of the disclosure. Method 700 may be implemented by system 101, specifically inquiry module 107, and may include steps 702-708 as described below. Some of the steps may be optional to perform the disclosure provided herein. Further, some of the steps may be performed simultaneously, or in a different order than that shown in FIG. 7.

At step 702, inquiry module 107 receives a request including one or more parameters.

For example, a user may operate user device 112 to provide a request to inquiry module 107. The request may specify one or more parameters such as a coordinate of a geographical location, a time (e.g., a date of the year), etc.

At step 704, inquiry module 107 generates a joint remote sensing image based on the one or more parameters.

At step 706, inquiry module 107 applies the joint remote sensing image to a dehazing deep learning model to generate a dehazed remote sensing image.

At step 708, inquiry module 107 presents the dehazed remote sensing image to the user through user device 112.

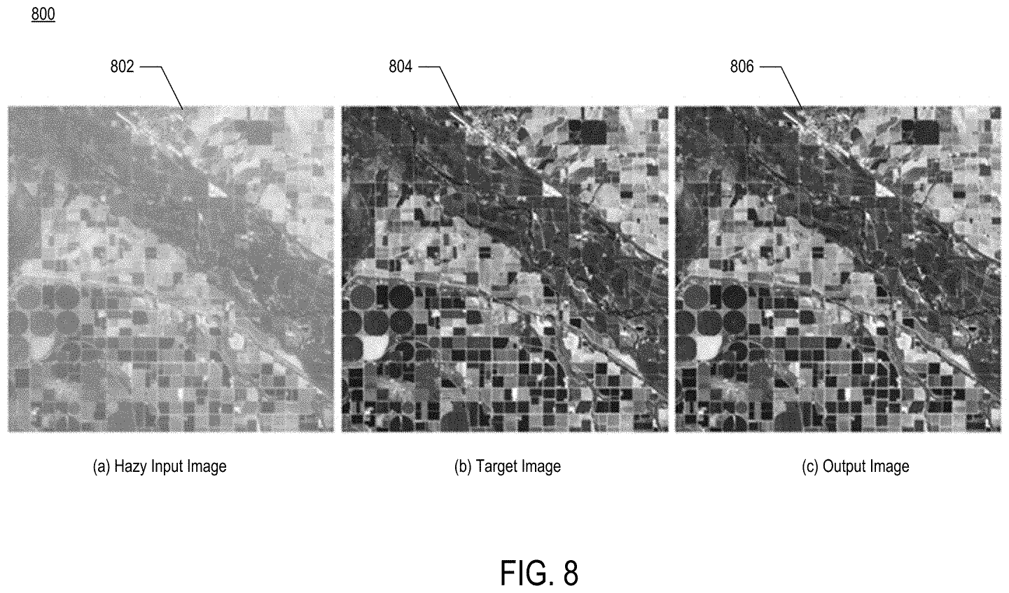

FIG. 8 is a graphical representation illustrating an exemplary comparison 800 of a hazy input image 802, a target image 804, and an output image 806, according to embodiments of the disclosure. A dehazing deep learning model may be trained by performing operations similar to those described above. Hazy input image 802 may be fed into the trained dehazing deep learning model to generate output image 806. By comparing output image 806 with target image 804, it is noted that the dehazing deep learning model can effectively remove haze from hazy input image 802 to produce output image 806 that is haze-free.

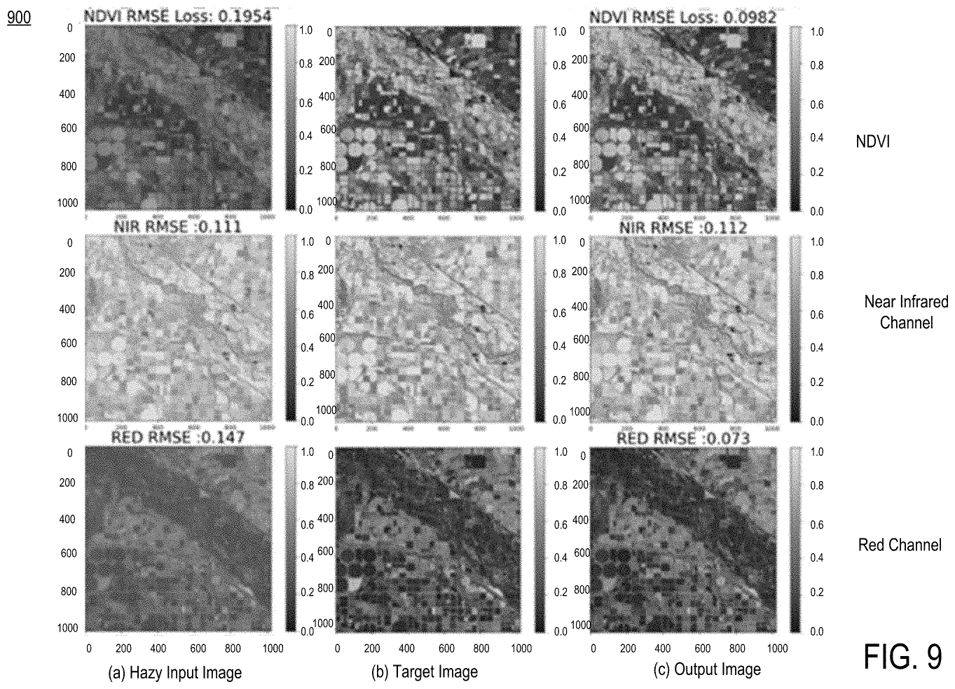

FIG. 9 is a graphical representation illustrating an exemplary NDVI result 900, according to embodiments of the disclosure. In FIG. 9, pictures in a first column may include an NDVI map, a channel map for the near infrared channel, and a channel map for the red channel for a hazy input image, respectively. Pictures in a second column may include an NDVI map, a channel map for the near infrared channel, and a channel map for the red channel for a target image corresponding to the hazy input image, respectively. Pictures in a third column may include an NDVI map, a channel map for the near infrared channel, and a channel map for the red channel for an output image, respectively. The output image may be generated by dehazing deep learning model 212 by taking the hazy input image as an input.

Consistent with the disclosure, an NDVI map for an image may depict an NDVI value of each pixel in the image. A channel map for a particular channel may depict a pixel value of the particular channel of each pixel in the image. For example, a channel map for the red channel may depict a pixel value of the red channel of each pixel in the image.

As shown in FIG. 9, an error between the NDVI map of the output image and the NDVI map of the target image is much smaller than an error between the NDVI map of the hazy input image and the NDVI map of the target image. Through an application of dehazing deep learning model 212, NDVI values of pixels in the output image are close to NDVI values of pixels in the targe image, which demonstrates that dehazing deep learning model 212 can be applied to effectively monitor a growth status for crops on a farmland even if the farmland is located in a hazy geographical region.

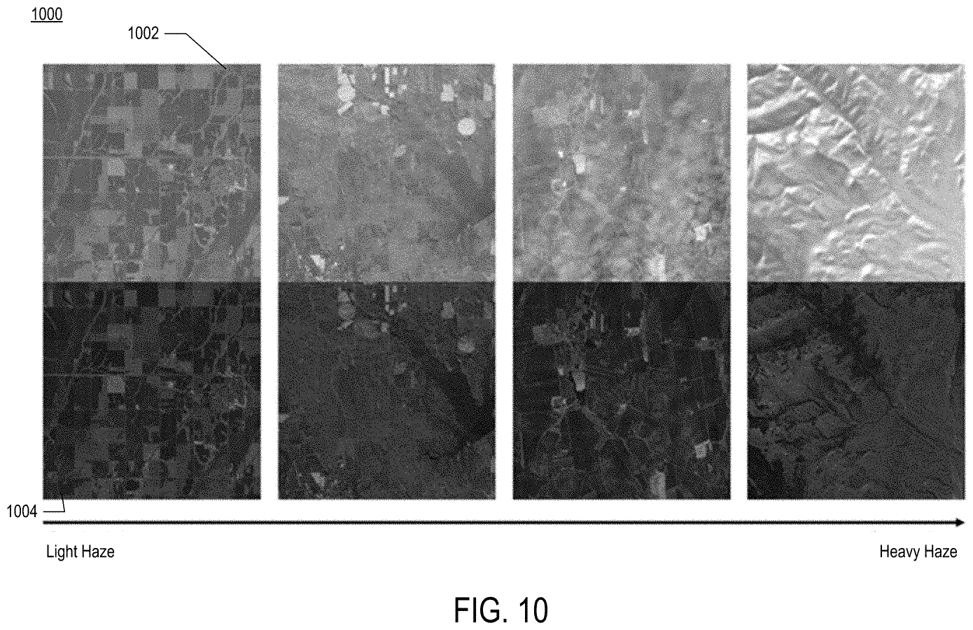

FIG. 10 is a graphical representation illustrating an exemplary performance 1000 of dehazing deep learning model 212, according to embodiments of the disclosure. Images in a first row of FIG. 10 represent four hazy input images with different degrees of haze (e.g., from light haze to heavy haze). Images in a second row of FIG. 10 represent four output images corresponding to the four hazy input images, respectively. The four hazy input images are fed into dehazing deep learning model 212 to generate the four output images, respectively. From FIG. 10, it is noted that dehazing deep learning model 212 may process hazy input images with different degrees of haze and generate corresponding dehazed output images thereof.

In some embodiments, a performance of dehazing deep learning model 212 may be evaluated using a peak signal-to-noise ratio (PSNR) and a structural similarity (SSIM). After dehazing deep learning model 212 is trained, a plurality of hazy input images that are not involved in the training of dehazing deep learning model 212 can be fed into the trained dehazing deep learning model 212 to generate a plurality of output images, respectively. For each output image, a PSNR and an SSIM is calculated for the output image by comparing the output image to a corresponding target image. As a result, a plurality of PSNRs and a plurality of SSIMs may be generated for the plurality of output images. An average PSNR and an average SSIM can be determined from the plurality of PSNRs and the plurality of SSIMs, respectively. The average PSNR and the average SSIM can be used to evaluate a performance of dehazing deep learning model 212. A higher average PSNR and/or a higher SSIM may demonstrate a better performance of dehazing deep learning model 212. For example, a higher average PSNR and/or a higher SSIM may indicate that the plurality of output images are closer to the corresponding target images when compared to a lower PSNR and/or a lower SSIM. In some examples, the average PSNR can be 28 dB, and the average SSIM can be 0.85.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

According to one aspect of the present disclosure, a method for removing haze from remote sensing images is disclosed. One or more hazy input images with at least four spectral channels and one or more target images with the at least four spectral channels are generated. The one or more hazy input images correspond to the one or more target images, respectively. A dehazing deep learning model is trained using the one or more hazy input images and the one or more target images. The dehazing deep learning model is provided for haze removal processing.

In some embodiments, the at least four spectral channels include a red channel, a green channel, a blue channel, and a near infrared channel.

In some embodiments, the at least four spectral channels further include one or more of a shortwave infrared channel and a mid-wave infrared channel.

In some embodiments, generating the one or more hazy input images and the one or more target images includes: generating, from a data source, one or more hazy image patches and one or more haze-free image patches corresponding to the one or more hazy image patches, respectively; filtering the one or more hazy image patches to generate the one or more hazy input images with the at least four spectral channels; and filtering the one or more haze-free image patches to generate the one or more target images with the at least four spectral channels.

In some embodiments, generating, from the data source, the one or more hazy image patches and the one or more haze-free image patches includes: retrieving a first original image and a second original image from the data source, where the first and second original images are original remote sensing images captured within a predetermined time window for an identical geographical location; determining an average dark-channel value for the first original image and an average dark-channel value for the second original image; and responsive to the average dark-channel value of the first original image being equal to or greater than a first dark-channel threshold and the average dark-channel value of the second original image being smaller than a second dark-channel threshold, generating at least one hazy image patch from the first original image and at least one haze-free image patch corresponding to the at least one hazy image patch from the second original image.

In some embodiments, generating the at least one hazy image patch from the first original image and the at least one haze-free image patch from the second original image includes: dividing the first original image into a plurality of first image patches and the second original image into a plurality of second image patches, where the plurality of first image patches correspond to the plurality of second image patches, respectively; and for each first image patch, determining an average dark-channel value for the first image patch and an average dark-channel value for a second image patch corresponding to the first image patch; and responsive to the average dark-channel value of the first image patch being equal to or greater than the first dark-channel threshold and the average dark-channel value of the second image patch being smaller than the second dark-channel threshold, determining the first image patch to be a hazy image patch and the second image patch to be a haze-free image patch corresponding to the hazy image patch.

In some embodiments, an evaluation of a crop growth analysis parameter is incorporated into the dehazing deep learning model through a loss value of the dehazing deep learning model.

In some embodiments, the crop growth analysis parameter includes an NDVI.

In some embodiments, training the dehazing deep learning model includes: feeding the one or more hazy input images to the dehazing deep learning model to generate one or more output images; determining the loss value of the dehazing deep learning model based on the one or more output images and the one or more target images; and adjusting one or more parameters of the dehazing deep learning model based on the loss value.

In some embodiments, determining the loss value of the dehazing deep learning model based on the one or more output images and the one or more target images includes: determining, using pixels in the one or more output images and pixels in the one or more target images, a first value of a first loss function with respect to the at least four spectral channels and the crop growth analysis parameter. The loss value of the dehazing deep learning model is equal to the first value of the first loss function.

In some embodiments, information of an atmospheric physical model is incorporated into the dehazing deep learning model through the loss value of the dehazing deep learning model.

In some embodiments, determining the loss value of the dehazing deep learning model based on the one or more output images and the one or more target images includes: determining, using pixels in the one or more output images and pixels in the one or more target images, a first value of a first loss function with respect to the at least four spectral channels and the crop growth analysis parameter; determining a second value of a second loss function that incorporates the information of the atmospheric physical model into the dehazing deep learning model; and combining the first value of the first loss function and the second value of the second loss function to generate the loss value.

In some embodiments, determining the second value of the second loss function includes: applying a forward mode of the atmospheric physical model to the one or more target images to generate one or more virtual hazy images; applying a reverse mode of the atmospheric physical model to the one or more virtual hazy images to generate one or more miss-corrected images; and determining the second value of the second loss function based on the one or more output images, the one or more target images, and the one or more miss-corrected images.

In some embodiments, the loss value of the dehazing deep learning model is a weighted sum of the first value of the first loss function and the second value of the second loss function.

In some embodiments, the first loss function includes an L1 loss function and the second loss function includes a contrastive loss function.

In some embodiments, the atmospheric physical model includes an atmospheric radiation transmission model.

In some embodiments, a request including one or more parameters is received. A joint remote sensing image is generated based on the one or more parameters. The joint remote sensing image is applied to the dehazing deep learning model to generate a dehazed remote sensing image.

According to another aspect of the present disclosure, a system for removing haze from remote sensing images is disclosed. The system includes a memory configured to store instructions and a processor coupled to the memory and configured to execute the instructions to perform a process. The process includes generating one or more hazy input images with at least four spectral channels and one or more target images with the at least four spectral channels. The one or more hazy input images correspond to the one or more target images, respectively. The process further includes training a dehazing deep learning model using the one or more hazy input images and the one or more target images. The process additionally includes providing the dehazing deep learning model for haze removal processing.

In some embodiments, the at least four spectral channels include a red channel, a green channel, a blue channel, and a near infrared channel.

In some embodiments, the at least four spectral channels further include one or more of a shortwave infrared channel and a mid-wave infrared channel.

In some embodiments, to generate the one or more hazy input images and the one or more target images, the process further includes: generating, from a data source, one or more hazy image patches and one or more haze-free image patches corresponding to the one or more hazy image patches, respectively; filtering the one or more hazy image patches to generate the one or more hazy input images with the at least four spectral channels; and filtering the one or more haze-free image patches to generate the one or more target images with the at least four spectral channels.

In some embodiments, to generate, from the data source, the one or more hazy image patches and the one or more haze-free image patches, the process further includes: retrieving a first original image and a second original image from the data source, where the first and second original images are original remote sensing images captured within a predetermined time window for an identical geographical location; determining an average dark-channel value for the first original image and an average dark-channel value for the second original image; and responsive to the average dark-channel value of the first original image being equal to or greater than a first dark-channel threshold and the average dark-channel value of the second original image being smaller than a second dark-channel threshold, generating at least one hazy image patch from the first original image and at least one haze-free image patch corresponding to the at least one hazy image patch from the second original image.

In some embodiments, to generate the at least one hazy image patch from the first original image and the at least one haze-free image patch from the second original image, the process further includes: dividing the first original image into a plurality of first image patches and the second original image into a plurality of second image patches, where the plurality of first image patches correspond to the plurality of second image patches, respectively; and for each first image patch, determining an average dark-channel value for the first image patch and an average dark-channel value for a second image patch corresponding to the first image patch; and responsive to the average dark-channel value of the first image patch being equal to or greater than the first dark-channel threshold and the average dark-channel value of the second image patch being smaller than the second dark-channel threshold, determining the first image patch to be a hazy image patch and the second image patch to be a haze-free image patch corresponding to the hazy image patch.

In some embodiments, an evaluation of a crop growth analysis parameter is incorporated into the dehazing deep learning model through a loss value of the dehazing deep learning model.

In some embodiments, the crop growth analysis parameter includes an NDVI.

In some embodiments, to train the dehazing deep learning model, the process further includes: feeding the one or more hazy input images to the dehazing deep learning model to generate one or more output images; determining the loss value of the dehazing deep learning model based on the one or more output images and the one or more target images; and adjusting one or more parameters of the dehazing deep learning model based on the loss value.

In some embodiments, to determine the loss value of the dehazing deep learning model based on the one or more output images and the one or more target images, the process further includes: determining, using pixels in the one or more output images and pixels in the one or more target images, a first value of a first loss function with respect to the at least four spectral channels and the crop growth analysis parameter. The loss value of the dehazing deep learning model is equal to the first value of the first loss function.

In some embodiments, information of an atmospheric physical model is incorporated into the dehazing deep learning model through the loss value of the dehazing deep learning model.

In some embodiments, to determine the loss value of the dehazing deep learning model based on the one or more output images and the one or more target images, the process further includes: determining, using pixels in the one or more output images and pixels in the one or more target images, a first value of a first loss function with respect to the at least four spectral channels and the crop growth analysis parameter; determining a second value of a second loss function that incorporates the information of the atmospheric physical model into the dehazing deep learning model; and combining the first value of the first loss function and the second value of the second loss function to generate the loss value.

In some embodiments, to determine the second value of the second loss function, the process further includes: applying a forward mode of the atmospheric physical model to the one or more target images to generate one or more virtual hazy images; applying a reverse mode of the atmospheric physical model to the one or more virtual hazy images to generate one or more miss-corrected images; and determining the second value of the second loss function based on the one or more output images, the one or more target images, and the one or more miss-corrected images.

In some embodiments, the loss value of the dehazing deep learning model is a weighted sum of the first value of the first loss function and the second value of the second loss function.

In some embodiments, the first loss function includes an L1 loss function and the second loss function includes a contrastive loss function.

In some embodiments, the atmospheric physical model includes an atmospheric radiation transmission model.

In some embodiments, the process further includes: receiving a request including one or more parameters; generating a joint remote sensing image based on the one or more parameters; and applying the joint remote sensing image to the dehazing deep learning model to generate a dehazed remote sensing image.

According to yet another aspect of the present disclosure, a non-transitory computer-readable storage medium is disclosed. The non-transitory computer-readable storage medium is configured to store instructions which, in response to an execution by a processor, cause the processor to perform a process. The process includes generating one or more hazy input images with at least four spectral channels and one or more target images with the at least four spectral channels. The one or more hazy input images correspond to the one or more target images, respectively. The process further includes training a dehazing deep learning model using the one or more hazy input images and the one or more target images. The process additionally includes providing the dehazing deep learning model for haze removal processing.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described exemplary implementations, but should be defined only in accordance with the following claims and their equivalents.

What is claimed is:

1. A computer-implemented method for removing haze from remote sensing images, comprising:
generating one or more hazy input images with at least four spectral channels and one or more target images with the at least four spectral channels, wherein the one or more hazy input images correspond to the one or more target images, respectively;
training a dehazing deep learning model using the one or more hazy input images and the one or more target images; and
providing the dehazing deep learning model for haze removal processing.

2. The method of claim 1, wherein the at least four spectral channels comprise a red channel, a green channel, a blue channel, and a near infrared channel.

3. The method of claim 2, wherein the at least four spectral channels further comprise one or more of a shortwave infrared channel and a mid-wave infrared channel.

4. The method of claim 1, wherein generating the one or more hazy input images and the one or more target images comprises:
generating, from a data source, one or more hazy image patches and one or more haze-free image patches corresponding to the one or more hazy image patches, respectively;
filtering the one or more hazy image patches to generate the one or more hazy input images with the at least four spectral channels; and
filtering the one or more haze-free image patches to generate the one or more target images with the at least four spectral channels.

5. The method of claim 4, wherein generating, from the data source, the one or more hazy image patches and the one or more haze-free image patches comprises:
retrieving a first original image and a second original image from the data source, wherein the first and second original images are original remote sensing images captured within a predetermined time window for an identical geographical location;
determining an average dark-channel value for the first original image and an average dark-channel value for the second original image; and
responsive to the average dark-channel value of the first original image being equal to or greater than a first dark-channel threshold and the average dark-channel value of the second original image being smaller than a second dark-channel threshold, generating at least one hazy image patch from the first original image and at least one haze-free image patch corresponding to the at least one hazy image patch from the second original image.

6. The method of claim 5, wherein generating the at least one hazy image patch from the first original image and the at least one haze-free image patch from the second original image comprises:
dividing the first original image into a plurality of first image patches and the second original image into a plurality of second image patches, wherein the plurality of first image patches correspond to the plurality of second image patches, respectively; and
for each first image patch,
determining an average dark-channel value for the first image patch and an average dark-channel value for a second image patch corresponding to the first image patch; and
responsive to the average dark-channel value of the first image patch being equal to or greater than the first dark-channel threshold and the average dark-channel value of the second image patch being smaller than the second dark-channel threshold, determining the first image patch to be a hazy image patch and the second image patch to be a haze-free image patch corresponding to the hazy image patch.

7. The method of claim 1, wherein an evaluation of a crop growth analysis parameter is incorporated into the dehazing deep learning model through a loss value of the dehazing deep learning model.

8. The method of claim 7, wherein the crop growth analysis parameter comprises a normalized differential vegetation index (NDVI).

9. The method of claim 7, wherein training the dehazing deep learning model comprises:
feeding the one or more hazy input images to the dehazing deep learning model to generate one or more output images;
determining the loss value of the dehazing deep learning model based on the one or more output images and the one or more target images; and
adjusting one or more parameters of the dehazing deep learning model based on the loss value.

10. The method of claim 9, wherein determining the loss value of the dehazing deep learning model based on the one or more output images and the one or more target images comprises:
determining, using pixels in the one or more output images and pixels in the one or more target images, a first value of a first loss function with respect to the at least four spectral channels and the crop growth analysis parameter,
wherein the loss value of the dehazing deep learning model is equal to the first value of the first loss function.

11. The method of claim 9, wherein information of an atmospheric physical model is incorporated into the dehazing deep learning model through the loss value of the dehazing deep learning model.

12. The method of claim 11, wherein determining the loss value of the dehazing deep learning model based on the one or more output images and the one or more target images comprises:
determining, using pixels in the one or more output images and pixels in the one or more target images, a first value of a first loss function with respect to the at least four spectral channels and the crop growth analysis parameter;
determining a second value of a second loss function that incorporates the information of the atmospheric physical model into the dehazing deep learning model; and
combining the first value of the first loss function and the second value of the second loss function to generate the loss value.

13. The method of claim 12, wherein determining the second value of the second loss function comprises:
applying a forward mode of the atmospheric physical model to the one or more target images to generate one or more virtual hazy images;
applying a reverse mode of the atmospheric physical model to the one or more virtual hazy images to generate one or more miss-corrected images; and
determining the second value of the second loss function based on the one or more output images, the one or more target images, and the one or more miss-corrected images.

14. The method of claim 12, wherein the loss value of the dehazing deep learning model is a weighted sum of the first value of the first loss function and the second value of the second loss function.

15. The method of claim 12, wherein the first loss function comprises an L1 loss function and the second loss function comprises a contrastive loss function.

16. The method of claim 11, wherein the atmospheric physical model comprises an atmospheric radiation transmission model.

17. The method of claim 1, further comprising:
receiving a request comprising one or more parameters;
generating a joint remote sensing image based on the one or more parameters; and
applying the joint remote sensing image to the dehazing deep learning model to generate a dehazed remote sensing image.

18. A system for removing haze from remote sensing images, comprising:
a memory configured to store instructions; and
a processor coupled to the memory and configured to execute the instructions to perform a process comprising:
generating one or more hazy input images with at least four spectral channels and one or more target images with the at least four spectral channels, wherein the one or more hazy input images correspond to the one or more target images, respectively;
training a dehazing deep learning model using the one or more hazy input images and the one or more target images; and
providing the dehazing deep learning model for haze removal processing.

19. The system of claim 18, wherein the at least four spectral channels comprise a red channel, a green channel, a blue channel, and a near infrared channel.

20. A non-transitory computer-readable storage medium configured to store instructions which, in response to an execution by a processor, cause the processor to perform a process comprising:
generating one or more hazy input images with at least four spectral channels and one or more target images with the at least four spectral channels, wherein the one or more hazy input images correspond to the one or more target images, respectively;
training a dehazing deep learning model using the one or more hazy input images and the one or more target images; and
providing the dehazing deep learning model for haze removal processing.
